(19) United States
(12) Patent Application Publication
(10) Pub. No.: US 2025/0118730 A1
(43) Pub. Date: Apr. 10, 2025

(54) Electrode and Electrochemical Device Including the Same

(71) Applicant: LG Energy Solution, Ltd., Seoul (KR)

(72) Inventors: Hyeon-Jeong Kang, Daejeon (KR); Young-Sun Park, Daejeon (KR); Yong-Jun Kim, Daejeon (KR); Moon-Soo Park, Daejeon (KR)

(73) Assignee: LG Energy Solution, Ltd., Seoul (KR)

(21) Appl. No.: 18/988,144

(22) Filed: Dec. 19, 2024

Related U.S. Application Data
(63) Continuation-in-part of application No. PCT/KR2023/011268, filed on Aug. 1, 2023.

(30) Foreign Application Priority Data
Aug. 1, 2022 (KR) 10-2022-0095678
Aug. 23, 2022 (KR) 10-2022-0105751

(51) Int. Cl. H01M 4/133; H01M 4/02; H01M 4/04; H01M 4/1393

(52) U.S. Cl. CPC H01M 4/133; H01M 4/0404; H01M 4/0435; H01M 4/1393; H01M 2004/021; H01M 2004/027; H01M 2004/028

(57) ABSTRACT

An electrode for an electrochemical device has a lower layer zone and an upper layer zone, wherein different types of granules are contained in the lower layer zone and the upper layer zone. In addition, the electrode includes an intermediate layer zone disposed between the lower layer zone and the upper layer zone and having an interface formed by undulating concave and convex portions having a quadrangular shape. The electrode shows an increased ion diffusion rate and electrode capacity.

### CROSS-REFERENCE TO RELATED APPLICATIONS

The present application is a continuation-in-part of PCT/KR2023/011268, filed on Aug. 1, 2023, which claims priority to Korean Patent Application No. 10-2022-0095678 filed on Aug. 1, 2022 and Korean Patent Application No. 10-2022-0105751 filed on Aug. 23, 2022 in the Republic of Korea, the disclosures of which are incorporated herein by reference.

### TECHNICAL FIELD

The present disclosure relates to an electrode and an electrochemical device including the same.

### BACKGROUND ART

Due to a rapid increase in the use of fossil fuels, there has been an increasing need for the use of substitute energy and clean energy. The most actively studied field as a part of attempts to meet such a need is the field of power generation and power storage using electrochemistry. Typical examples of electrochemical devices using such electrochemical energy include secondary batteries, the application spectrum of which tends to be extended more and more. A lithium secondary battery as a representative of such secondary batteries has been used not only as an energy source for mobile instruments but also as a power source for electric vehicles and hybrid electric vehicles capable of substituting for vehicles, such as gasoline vehicles and diesel vehicles, which use fossil fuel and are regarded as one of the main causes of air pollution recently. In addition, applications for such a lithium secondary battery have been extended even to a supplementary source of electric power through the electric grid.

Recently, various studies have been conducted on the development of batteries using a plurality of different electrode active materials, in order to improve battery performance. However, when a plurality of different electrode active materials are blended to form a single electrode active material layer, there can result problems of degradation of the performance of the battery due to the interference effect of different types of active materials. There has been considered methods of forming multilayer-type electrode active material layers in which each layer has a specialized function in improving the characteristics of an electrode and the performance of the battery.

In general, different types of electrode active materials may exhibit differences in ion diffusion rate and electrode capacity per unit weight or volume. There have been attempts to manufacture multilayer electrodes having a layer including an electrode active material showing a high ion diffusion rate and low electrode capacity and a layer including an electrode active material showing a low ion diffusion rate and high electrode capacity. However, it is believed that it is not possible to realize an electrode showing an improved ion diffusion rate and electrode capacity at the same time.

### DISCLOSURE

### Technical Problem

The present disclosure is designed to solve the problems of the related art, and therefore the present disclosure is directed to providing a multilayer electrode realizing both a high ion diffusion rate and a large electrode capacity, and a method for manufacturing the same.

The present disclosure is also directed to providing an electrode showing the above-mentioned characteristics by a method to which a dry process is introduced, and a method for manufacturing the electrode.

### Technical Solution

In accordance with the present disclosure, there is provided an electrode according to any one of the following aspects.

According to a first aspect of the present disclosure, there is provided an electrode including a current collector and an electrode active material layer disposed on at least one surface of the current collector. The current collector may define a plane having a first lateral dimension and a second lateral dimension orthogonal to one another. The electrode active material layer may include: a lower layer zone adjacent to the current collector and including a plurality of first granules; an upper layer zone disposed above the lower layer zone and including a plurality of second granules; and an intermediate layer zone which is disposed between the lower layer zone and the upper layer zone and in which a first unit zone including the first granules and a second unit zone including the second granules are disposed in an alternating pattern that alternates along the first lateral dimension of the current collector. Each of the first unit zone and the second unit zone may have a quadrangular shaped cross-section along a cross-sectional plane oriented orthogonally to the plane of the current collector and extending along the first lateral dimension. The first granules may include a first electrode active material and a first binder for binding the first electrode active material. The second granules may include a second electrode active material and a second binder for binding the second electrode active material.

According to a second aspect of the present disclosure, there is provided the electrode as defined in the first aspect, wherein the first lateral dimension may correspond to a longitudinal dimension of the current collector.

According to a third aspect of the present disclosure, there is provided the electrode as defined in the first aspect or the second aspect, wherein the alternating pattern may alternate from once every 20 mm to once every 34 mm along the first lateral dimension of the current collector.

According to a fourth aspect of the present disclosure, there is provided the electrode as defined in any one of the first to third aspects, wherein the first unit zone and the second unit zone may be disposed in a second alternating patter that alternates along the second lateral dimension of the current collector.

According to a fifth aspect of the present disclosure, there is provided the electrode as defined in the fourth aspect, wherein the first unit zone may have a first width in the first dimension, a second unit zone may have a second width in the first dimension, the first unit zone may have a third width in the second dimension, and the second unit zone may have a fourth width in the second dimension. Moreover, at least one of the first and second widths may have a different magnitude than at least one of the third and fourth widths.

According to a sixth aspect of the present disclosure, there is provided the electrode as defined in any one of the first to the fifth aspects, wherein the first granules and the second granules may satisfy at least one of the following characteristics:
1) a first characteristic that the particle size of the first granules and that of the second granules are different from each other; or
2) a second characteristic that the composition of the first granules and that of the second granules are different from each other.

According to a seventh aspect of the present disclosure, there is provided the electrode as defined in any one of the first to the sixth aspects, wherein the quadrangular shaped cross-section of each of the first unit zone and the second unit zone of the intermediate layer zone may satisfy the following conditions of T1, T2, W1, and W2:
d1≤T1,
d2≤T2,
50 d1≤W1≤1,000 d1,
50 d2≤W2≤1,000 d2, where:

T1 is the thickness of the first unit zone, T2 is the thickness of the second unit zone, W1 is the width of the first unit zone, W2 is the width of the second unit zone, d1 is the average particle diameter (D₅₀) of the first granules, and d2 is the average particle diameter (D₅₀) of the second granules.

According to an eighth aspect of the present disclosure, there is provided the electrode as defined in any one of the first to the seventh aspects, wherein the cross-sectional shape of each of the first unit zone and the second unit zone of the intermediate layer zone may satisfy the following conditions of T1, T2, W1 and W2:
d1≤T1≤2 d1,
d2≤T2≤2 d1,
100 d1≤W1≤600 d1, and
100 d2≤W2≤600 d2.

According to a ninth aspect of the present disclosure, there is provided the electrode as defined in any one of the first to the eighth aspects, wherein when the average particle diameter (D₅₀) of the first granules is d1 and the average particle diameter (D₅₀) of the second granules is d2, then d2≥d1.

According to a tenth aspect of the present disclosure, there is provided the electrode as defined in any one of the first to the ninth aspects, wherein when the average particle diameter (D₅₀) of the first granules is d1 and the average particle diameter (D₅₀) of the second granules is d2, then 15 μm≤d1≤150 μm, and 15 μm≤d2≤150 μm.

According to an eleventh aspect of the present disclosure, there is provided the electrode as defined in any one of the first to the tenth aspects, wherein the electrode active material may include a negative electrode active material.

According to a twelfth aspect of the present disclosure, there is provided the electrode as defined in any one of the first to the eleventh aspects, wherein the electrode active material may include a positive electrode active material.

According to a thirteenth aspect of the present disclosure, there is provided the electrode as defined in any one of the first to the twelfth aspects, wherein at least one of the first electrode active material or the second electrode active material may include a carbonaceous compound, and at least one of the first electrode active material or the second electrode active material may include a silicon-based oxide.

According to a fourteenth aspect of the present disclosure, there is provided the electrode as defined in any one of the first to the thirteenth aspects, wherein the second electrode active material may include SiOₓ (where 0≤x≤2).

According to a fifteenth aspect of the present disclosure, there is provided the electrode as defined in any one of the first to the fourteenth aspects, wherein the content of the first granules in the lower layer zone may be 95 wt % or more of the total weight of the granules contained in the lower layer zone, and the content of the second granules in the upper layer zone may be 95 wt % or more of the total weight of the granules contained in the upper layer zone.

According to a sixteenth aspect of the present disclosure, there is provided the electrode as defined in any one of the first to the fifteenth aspects, wherein the intermediate layer zone may have an ion diffusion rate higher than the ion diffusion rate of the upper layer zone.

According to a seventeenth aspect of the present disclosure, there is provided the electrode as defined in any one of the first to the sixteenth aspects, wherein the upper layer zone may have an electrode capacity per volume higher than the electrode capacity per volume of the lower layer zone.

In accordance with the present disclosure, there is provided a method for manufacturing an electrode according to any one of the following aspects.

According to an eighteenth aspect of the present disclosure, there is provided a method for manufacturing an electrode including a process of forming an electrode active material layer on at least one surface of a current collector. The process of forming the electrode active material layer may include the steps of:
applying a plurality of first granules onto at least one surface of the current collector; a first pressurization step of pressurizing the applied first granules towards the surface of the current collector to form a pattern of the first granules by using a pressurizing roll defining the pattern; applying a plurality of second granules onto the pattern of the pressurized first granules; and a second pressurization step of pressurizing the applied second granules towards the surface of the current collector. The first granules may include a first electrode active material and a first binder for binding the first electrode active material, and the second granules may include a second electrode active material and a second binder for binding the second electrode active material.

According to a nineteenth aspect of the present disclosure, there is provided the method for manufacturing an electrode as defined in the eighteenth aspect, wherein the first granules and the second granules may satisfy at least one of the following characteristics:
1) a first characteristic that the particle size of the first granules and that of the second granules are different from each other; or
2) a second characteristic that the composition of the first granules and that of the second granules are different from each other.

According to a twentieth aspect of the present disclosure, there is provided the method for manufacturing an electrode as defined in the eighteenth or the nineteenth aspect, wherein the pressurization roll may have a protrusion-type pattern or a mesh-type pattern.

According to a twenty-first aspect of the present disclosure, there is provided the method for manufacturing an electrode as defined in any one of the eighteenth to the twentieth aspects, wherein the pattern of the pressurizing roll may include a plurality of quadrangular protrusions, and the shape of the protrusions may satisfy the following conditions of W3, W4, and T3:
d2≤T3
50 d2≤W3≤1,000 d2, and
50 d1≤W4≤1,000 d1, where:

W3 is the width of the protruding portion of the protrusion, W4 is the shortest linear distance between two protrusions, T3 is the thickness of the protruding portion of the protrusion, d1 is the average particle diameter (D₅₀) of the first granules, and d2 is the average particle diameter (D₅₀) of the second granules.

According to a twenty-second aspect of the present disclosure, there is provided the method for manufacturing an electrode as defined in any one of the eighteenth to the twenty-first aspects, wherein the surface of the current collector defines a plane having a first lateral dimension and a second lateral dimension orthogonal to one another. Moreover, the electrode active material layer may include: a lower layer zone adjacent to the current collector and including a plurality of first granules; an upper layer zone disposed above the lower layer zone and including a plurality of second granules; and an intermediate layer zone which is disposed between the lower layer zone and the upper layer zone and in which a first unit zone including the first granules and a second unit zone including the second granules are disposed in an alternating pattern that alternates along the first lateral dimension of the current collector, and each of the first unit zone and the second unit zone has a quadrangular shaped cross-section along a cross-sectional plane, which cross-sectional plane is oriented orthogonally to the plane of the current collector and extends along the first lateral dimension.

In accordance with the present disclosure, there is provided an electrochemical device according to the following aspect.

According to a twenty-third aspect of the present disclosure, there is provided an electrochemical device including a positive electrode, a negative electrode, a separator interposed between the positive electrode and the negative electrode, and an electrolyte. Moreover, at least one of the positive electrode or the negative electrode may be the electrode as defined in any one of the first to the seventeenth aspects.

### Advantageous Effects

The electrode according to aspects of the present disclosure may show an improved ion diffusion rate and/or electrode capacity.

For example, the electrode according to aspects of the present disclosure may have an improved ion diffusion rate, or may have an improved electrode capacity while realizing a similar level of ion diffusion rate, as compared to not only an electrode having a single layer but also to a multilayer electrode including an intermediate layer zone having a flat interface.

An electrode according to aspects of the present disclosure may have an improved electrode capacity while maintaining a similar level of resistance as compared to a multilayer electrode including an intermediate layer zone having a flat linear shaped interface.

A method for manufacturing an electrode according to other aspects of the present disclosure may provide an electrode having the above-described characteristics.

### DESCRIPTION OF DRAWINGS

The accompanying drawings illustrate aspects of the present disclosure and, together with the foregoing disclosure, serve to provide further understanding of the technical features of the present disclosure. Thus, the present disclosure is not to be construed as limited to the drawings.

FIG. 1 is a schematic view illustrating the electrode active material layer in the electrode according to an aspect of the present disclosure.

FIG. 2 is a schematic view illustrating the electrode active material layer in the electrode according to another aspect of the present disclosure.

FIG. 3 is a schematic view illustrating the electrode active material layer in the electrode according to still another aspect of the present disclosure.

FIG. 4 is a schematic view illustrating the electrode active material layer in the electrode according to an aspect of the present disclosure.

FIG. 5 is a schematic view illustrating the electrode active material layer in the electrode according to an aspect of the present disclosure.

FIG. 6 is a series of illustrations showing the method for manufacturing an electrode according to an aspect of the present disclosure.

FIG. 7 includes photographic images illustrating the patterns of a pressurizing roll used in the method for manufacturing an electrode according to an aspect of the present disclosure.

FIG. 8 is a side view illustrating a pressurizing roll having a pattern, used in manufacturing an electrode according to an aspect of the present disclosure.

FIG. 9 is a schematic view illustrating an electrode assembly using the electrode according to an aspect of the present disclosure.

FIG. 10 is a schematic view illustrating an electrode assembly using the electrode according to Example 1 described hereinafter.

FIG. 11 is a schematic view illustrating an electrode assembly using the electrode according to Example 2 described hereinafter.

FIG. 12 is a schematic view illustrating an electrode assembly using the electrode according to Example 3 described hereinafter.

FIG. 13 is a perspective view of a portion of an electrode assembly, illustrating an exemplary pattern of the intermediate layer zone, showing how each of the first and second unit zones extend linearly across the entire width of the electrode while alternating along the longitudinal dimension of the electrode.

FIG. 14 is a perspective view of a portion of an electrode assembly, illustrating an exemplary pattern of the intermediate layer zone, showing how each of the first and second unit zones extend linearly across the entire length of the electrode while alternating along the width dimension of the electrode.

FIG. 15 is a perspective view of a portion of an electrode assembly, illustrating an exemplary pattern of the intermediate layer zone, showing how each of the first and second unit zones extend linearly across both of the entire width and the entire length of the electrode with a checkerboard-like pattern.

FIG. 16 is a schematic view of a granule as an electrode active material.

### BEST MODE

Hereinafter, preferred embodiments of the present disclosure will be described in detail. However, the description proposed herein merely relates to preferred examples for the purpose of illustration only, and it is not intended to limit the scope of the disclosure. It is to be understood that each constitutional element may alternatively be modified or may be combined. Moreover, it is to be understood that other equivalents and modifications could be made to each element without departing from the scope of the disclosure.

Throughout the specification, an expression such as ‘a part includes an element’ does not preclude the presence of any additional elements, but rather means that the part may further include the other elements.

As used herein, the expression ‘A and/or B’ means ‘A, B, or both of them’.

The present disclosure relates to an electrode and an electrochemical device including the same. According to the present disclosure, the electrochemical device includes any device which carries out an electrochemical reaction, and particular examples thereof include all types of primary batteries, secondary batteries, fuel cells, solar cells, or capacitors, such as super capacitor devices. Preferably, the electrochemical device may be a secondary battery, and, more preferably, a lithium-ion secondary battery.

In one aspect of the present disclosure, there is provided an electrode including an active material layer having a multilayer structure.

In particular, the electrode may include: a current collector; and an electrode active material layer disposed on at least one surface of the current collector.

A vertical dimension from the current collector in the electrode to the surface of the electrode active material layer is referred to as the ‘thickness dimension’ of the electrode active material layer, and the dimensions orthogonal to the thickness dimension are referred to as ‘lateral dimensions’ of the electrode active material layer. Those lateral dimensions include a ‘first lateral dimension’ and a ‘second lateral dimension’ orthogonal to one another, where one of the first and second dimensions is a longitudinal dimension of the electrode and the other of the first and second dimensions is a width dimension of the electrode.

According to an aspect of the present disclosure, the electrode active material layer may include: a lower layer zone adjacent to the current collector and including a plurality of first granules; an upper layer zone disposed above the lower layer zone and including a plurality of second granules; and an intermediate layer zone which is disposed between the lower layer zone and the upper layer zone and in which a first unit zone including the first granules and a second unit zone including the second granules are disposed in an alternating pattern that alternates along the first lateral dimension of the current collector. Each of the first unit zone and the second unit zone may have a quadrangular shaped cross-section.

In addition, the first granules may include a first electrode active material and a first binder for binding the first electrode active material, and the second granules may include a second electrode active material and a second binder for binding the second electrode active material.

According to an aspect of the present disclosure, the size of the first granules and that of the second granules may be different from each other.

In the electrode according to an aspect of the present disclosure, the intermediate layer zone includes an interface having an undulating shape along the thickness dimension. The undulations may have quadrangular shapes defined by alternating the first unit zone and the second unit zone.

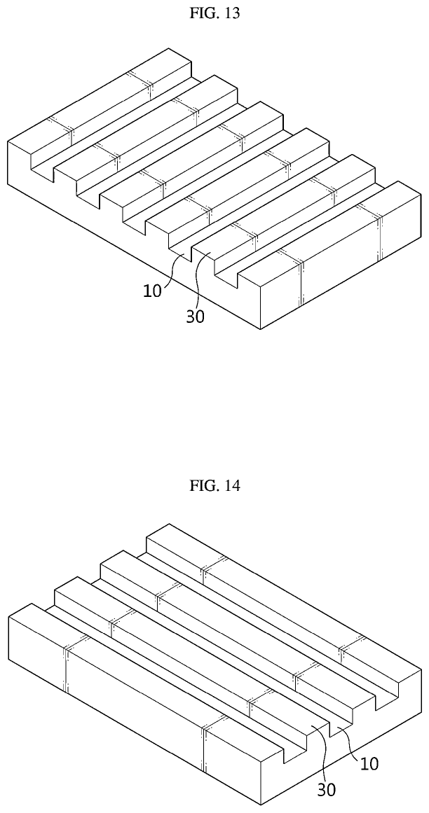

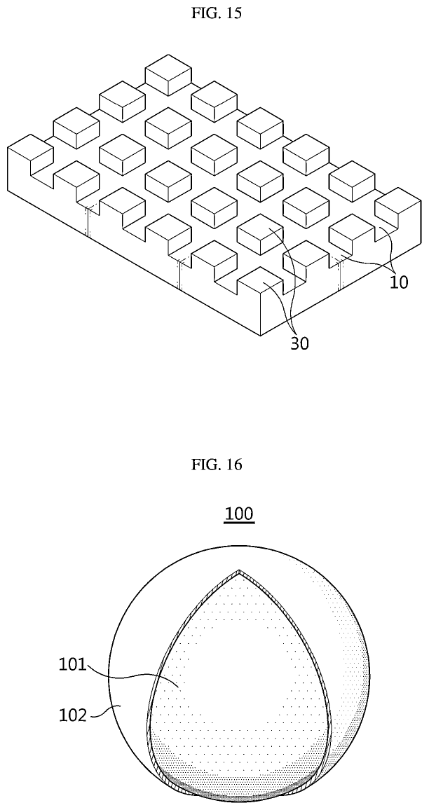

According to some aspects of the present disclosure, the undulations may result in the first and second unit zones alternating along the longitudinal dimension of the electrode, as illustrated in FIG. 13. According to other aspects of the present disclosure, the undulations may result in the first and second unit zones alternating along the width dimension of the electrode, as illustrated in FIG. 14. According to yet other aspects of the present disclosure, the first and second unit zones may alternate in both the width and longitudinal dimensions of the electrode, as illustrated in FIG. 15. Such two-dimensional alternations may result in a grid-like or checkerboard pattern of alternating protruding portions and recessed portions, as illustrated in the figure.

According to an aspect of the present disclosure, the first unit zone and the second unit zone may each be formed of granules having respective sizes that are different from one another. As a result, the ion diffusion rate may be increased at the interface. Particularly, according to an aspect of the present disclosure, the interface between the regions of granules of different sizes preferably has an increased surface area as compared to a multilayer electrode including a lower layer and an upper layer zone (each formed of granules having different respective sizes) in which the interface between those layers has a linear or planar shape. Accordingly, an advantageous effect in terms of an increase in ion diffusion rate is preferably achieved.

Particularly, according to an aspect of the present disclosure, when granules having advantageous kinetics of ion diffusion as compared to the lower layer zone are disposed in the upper layer zone, and an interface having a quadrangular shaped cross-section formed by alternating the first unit zone and the second unit zone is formed in the intermediate layer zone, the transport of lithium (ion) is desirably facilitated in the thickness dimension of the electrode, thereby realizing an effect of improving the charge capacity of the electrode.

For this purpose, according to an aspect of the present disclosure, the first granules disposed in the lower layer zone and the second granules disposed in the upper layer zone may satisfy at least one of the following characteristics:
1) a first characteristic that the particle size of the first granules and that of the second granules are different from each other; or
2) a second characteristic that the composition of the first granules and that of the second granules are different from each other.

According to an aspect of the present disclosure, the first characteristic is configured to make the granules have a different size regardless of the composition of granules so that the granules may have different capacity values and/or ion diffusion rates.

With reference to the first characteristic, according to an aspect of the present disclosure, the first granules and the second granules may have the same composition or may have different compositions.

The expression ‘granules have the same composition’ means that the types of active material, binder, conductive material (if it is further used), or the like, which are contained in the granules, as well as the weight ratios thereof, are the same. In contrast, the expression ‘granules have a different composition’ means that at least one of the types of active material, binder, conductive material (if it is further used), or the like, which are contained in the granules, is different, or the weight ratios thereof are different even if the above ingredients are of the same types.

According to an aspect of the present disclosure, the second characteristic is configured to make the granules have a different composition regardless of the size of granules so that the granules may have different capacity values and/or ion diffusion rates.

With reference to the second characteristic, according to an aspect of the present disclosure, the first granules and the second granules may be provided with the same size or a similar size, wherein ‘similar size’ may refer to a difference in particle diameter of +10% or less, preferably +5% or less.

According to an aspect of the present disclosure, each undulation of the first unit zone and the second unit zone in the thickness dimension may have a quadrangular shaped cross-section, such as square-shaped section or rectangular shaped section. Particularly, each of the first unit zone and the second unit zone may have a rectangular shaped section in which the width W1 and/or W2 in the first lateral dimension is larger than the height T1 and/or T2 in the thickness dimension. Moreover, such first lateral dimension may be either the longitudinal dimension or the width dimension of the electrode, or the magnitudes of width and thickness of the undulations may vary in both the longitudinal dimension and the width dimension of the electrode. For example, in some aspects, the width W1 of the first unit zone may be the same in both the longitudinal dimension and the width dimension of the electrode, and the width W2 of the second unit zone may be the same in both the longitudinal dimension and the width dimension of the electrode, such that the profiles of each of the first and second unit zones may be substantially square along the plane of the current collector. In another example, the width W1 in the longitudinal dimension may be different than the width W1 in the width dimension, and/or the width W2 in the longitudinal dimension may likewise be different than the width W2 in the width dimension, such that the profiles of each of the first and second unit zones may be substantially rectangular along the plane of the current collector. However, the scope of the present disclosure is not limited thereto.

Further, according to an aspect of the present disclosure, each of the first unit zone and the second unit zone may have a quadrangular shaped cross-section in a plane orthogonal to the current collector and extending along the first lateral dimension, and thus provides the interface 310 of the intermediate layer zone having an increased surface area as compared to the electrodes having interfaces of other shapes (e.g. triangular shape, trapezoidal shape, etc.), thereby realizing an advantageous effect in terms of improvement of the ion diffusion rate. In addition, it is possible to realize an advantageous effect in terms of improvement of the adhesive property between the lower layer zone and the upper layer zone by increasing the surface area of the interface 310 of the intermediate layer zone, but the effects of the present disclosure are not limited thereto.

According to an aspect of the present disclosure, ‘n’ represents the number of alternations of the first unit zone and the second unit zone along the intermediate layer zone in the first lateral dimension, where an alternation is defined as a change from the first unit zone to the second unit zone along the first lateral dimension. Moreover, n may be an integer of 2 or more. For example, n may be an integer of 2 or more, an integer of 3 or more, an integer of 4 or more, an integer of 5 or more, or an integer of 10 or more, and particularly, n may be an integer of 50 or less within the above-defined range, but the present disclosure is not limited thereto. For example, n may be an integer of 10-50, 15-40, 15-25, or 15-20.

Another characterization of a preferred number of alternations of the first unit zone and the second unit zone may be the density of such alternations over a defined length (or area). For example, the electrode may have from 1 alternation per 500 mm to 10 alternations per mm. More preferably, the density of alternations may range from 1 alternation per 70 mm to 5 alternations per mm. Even more preferably, the density of such alternations may range from 1 alternation per 40 mm to 1 alternation per 1.25 mm. Even more preferably, the density of alternations may range from 1 alternation per 40 mm to 1 alternation per 4 mm. Even more preferably, the density of alternations may range from 1 alternation per 37 mm to 1 alternation per 25 mm. Even more preferably, the density of alternations may range from 1 alternation per 26 mm to 1 alternation per 20 mm.

According to an aspect of the present disclosure, the electrode may have a variable size as necessary. For example, the electrode may have a length of 5-1,000 mm. In various examples, the electrode may have a length of 10-700 mm, 50-600 mm, 100-600 mm, or 500-550 mm. According to an aspect of the present disclosure, based on the length of the electrode ranging from 500 mm to 520 mm, such as 509.5 mm, n representing the number of alternation of the first unit zone and the second unit zone may be an integer of 10-50, such as an integer of 15-35, 20-30 or 20-25, preferably.

In addition, according to an aspect of the present disclosure, the electrode may have a variable size as necessary, including, for example, a width of 5-1,000 mm. For example, the electrode may have a width of 5-500 mm, 10-200 mm, 50-150 mm, 80-100 mm, or 90-100 mm, but is not limited thereto.

According to an aspect of the present disclosure, the electrode may have a rectangular shape with a length of 509.3 mm and a width of 93.3 mm.

Herein, the length of the electrode may refer to the size of the longer side when the electrode has a rectangular shape. The width of the electrode may refer to the dimension orthogonal to the longitudinal dimension of the electrode, and for example, may refer to the shorter side when the electrode has a rectangular shape.

The electrode active material layer may include an electrode active material and a binder as electrode materials. Particularly, the electrode materials may be contained in the electrode active material layer in the form of granules. The granules refer to composite particles including the electrode active material and the electrode binder. According to an aspect of the present disclosure, the granules may include the electrode active material particles bound by the electrode binder.

The electrode active material layer may further include free electrode active material particles derived from the granules, or the like.

According to an aspect of the present disclosure, the granules may be prepared by mixing the electrode active material with the electrode binder and carrying out granulation through spray drying, but the method for preparing the granules is not limited thereto.

According to an aspect of the present disclosure, the electrode active material layer may be formed by applying the granules to one surface of a current collector and carrying out pressurization without using any separate solvent, but the purpose of use and application of the granules are not limited thereto.

Detailed description of the structure and composition of the granules will be described hereinafter, and the structure of the electrode active material layer will be explained first.

According to the present disclosure, the electrode active material layer includes a plurality of granules integrated in a layered structure, has a plurality of fine pores defined by the interstitial volumes which are spaces among the granules, and shows porous property derived from such a structure. Herein, the ion diffusion rate of the electrode active material layer may be determined by some factors, such as the size and number of the fine pores, and the electrode capacity may be determined by the packing density of the granules.

According to an aspect of the present disclosure, the electrode active material layer includes a lower layer zone, intermediate layer zone, and an upper layer zone (in that order) layered on top of the current collector.

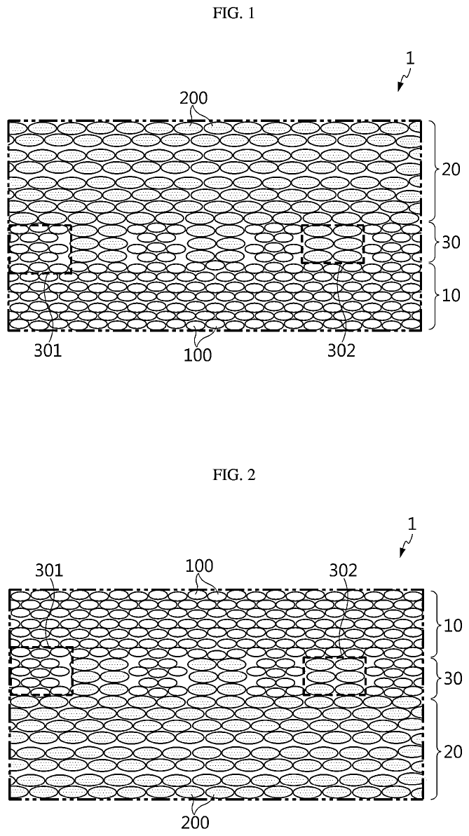

FIG. 1 is a schematic sectional view illustrating the electrode active material layer 1 in the electrode according to an aspect of the present disclosure.

Referring to FIG. 1, the electrode active material layer 1 includes a lower layer zone 10 adjacent to a current collector (not shown) and including a plurality of first granules 100, an upper layer zone 20 disposed above the lower layer zone and including a plurality of second granules 200, and an intermediate layer zone 30 disposed between the lower layer zone and the upper layer zone.

In the intermediate layer zone 30, a first unit zone 301 including the first granules 100 and a second unit zone 302 including the second granules 200 are disposed alternately n times along the longitudinal dimension of the electrode active material layer 1. Each of the first unit zone and the second unit zone has a quadrangular shaped cross-section along a cross-sectional plane that is orthogonal to the current collector and extends along the lateral (e.g., longitudinal) direction. Thus, a continuous undulating interface having a quadrangular shape is formed in the intermediate layer zone 30, due to the repetition of the first unit zone 301 and the second unit zone 302.

According to the present disclosure, the first granules and the second granules have a different particle size, and FIG. 1 shows an aspect in which the second granules 200 have a larger particle size than the particle size of the first granules 100.

FIG. 2 is a schematic sectional view illustrating the electrode active material layer 1 according to another aspect of the present disclosure. FIG. 2 shows an aspect in which the first granules 100 have a larger particle size than the particle size of the second granules 200.

According to an aspect of the present disclosure, the first granules and the second granules are different from each other in terms of particle size, and thus the electrode according to an aspect of the present disclosure has an electrode capacity different from the electrode capacity of an electrode using the first granules or the second granules alone. In addition, since the granules contained in the upper layer zone and the granules contained in the lower layer zone have a different particle size, the upper layer zone and the lower layer zone are formed to have a different porosity. Therefore, the electrode according to an aspect of the present disclosure has an ion diffusion rate different from the ion diffusion rate of an electrode using the first granules or the second granules alone.

In contrast, in an electrode having a flat interface, i.e. a linear or planar shaped interface, formed between layers in which the active material particles in each layer are of a variety of different sizes, the porosity of each layer is uniform, and thus no significant change in porosity occurs between the lower layer zone and the upper layer zone at the interface. On the other hand, when the active material particles forming the lower layer zone are smaller (and thus have a higher packing density) than those in the upper layer zone, there may be a phenomenon in which the lower layer zone has a decrease in porosity at the interface. In this case, when an electrolyte (liquid electrolyte) is introduced from the upper layer zone to the lower layer zone (which is adjacent to the current collector), the electrolyte wetting rate, i.e. the diffusion rate of lithium ions contained in the electrolyte, may be reduced in the vicinity of the interface, resulting in the problem of an increase in electrolyte wetting (lithium ion diffusion) time.

Therefore, according to an aspect of the present disclosure, there is provided a multilayer electrode including a lower layer zone and an upper layer zone using granules having a different particle size and/or a different composition, wherein the granules having a different particle size and/or different composition are incorporated between the lower layer zone and the upper layer zone to form an undulating interface in which a quadrangular shaped convex portion and a quadrangular shaped concave portion alternate with one another along a lateral dimension extending parallel to the current collector, thereby providing an increased interfacial surface area, which desirably improves the porosity in the middle of the active material layer and enhances the ion diffusion rate, but the mechanism of action of the present disclosure is not limited thereto.

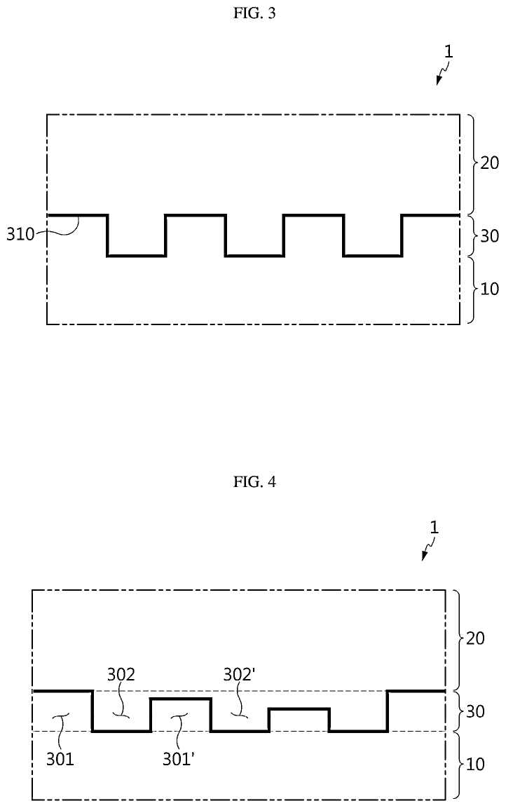

FIG. 3 is a schematic sectional view illustrating the electrode active material layer 1 in the electrode according to an aspect of the present disclosure. Referring to FIG. 3, it can be seen that there is a quadrangular shaped interface 310 formed by alternating a quadrangular first unit zone and a quadrangular second unit zone within the intermediate layer zone 30 of the electrode active material layer. The interface formed in the intermediate layer zone is an interface generated from a difference in the size and/or composition between the first granules of the first unit zone and the second granules of the second unit zone, as described above. For example, the interface 310 may be determined by observing the electrode with the naked eye or through scanning electron microscopy (SEM).

According to an aspect of the present disclosure, the interface may be determined through SEM observation.

According to an aspect of the present disclosure, when the first unit zone and the second unit zone are disposed alternately n times, the first unit zones may have the same or a different size shape in the cross-sectional plane, and the second unit zones may have the same or a different size shape in the cross-sectional plane.

According to an aspect of the present disclosure, in the case of an electrode in which the first unit zone and the second unit zone alternate n times and n is an even number, the electrode may include the first unit zone in the number of n/2 and the second unit zone in the number of n/2.

According to another aspect of the present disclosure, in the case of an electrode in which the first unit zone and the second unit zone alternate n times and n is an odd number, the electrode may include the first unit zone in the number of (n−1)/2 and the second unit zone in the number of (n+1)/2, or may include the first unit zone in the number of (n+1)/2 and the second unit zone in the number of (n−1)/2.

FIG. 4 is a sectional schematic view illustrating the electrode active material layer 1 in the electrode according to an aspect of the present disclosure. Referring to FIG. 4, in the intermediate layer zone 30, a plurality of first unit zones 301, 301′ and a plurality of second unit zones 302, 302′ are disposed alternately, wherein each of the first unit zones 301, 301′ has a quadrangular shaped cross-section but the cross-sectional shapes may be different from each other, and each of the second unit zones 302, 302′ has a quadrangular shaped cross-section but the cross-sectional shapes may be different from each other.

According to another aspect of the present disclosure, the first unit zones disposed in the intermediate layer zone 30 may have the same size shape in the cross-sectional plane, and the second unit zones may have the same size shape in the cross-sectional plane.

According to still another aspect of the present disclosure, the first unit zones disposed in the intermediate layer zone 30 may have the same size of shape in the cross-sectional plane and the second unit zones may have different size shapes in the cross-sectional plane, or the first unit zones disposed in the intermediate layer zone 30 may have different size shapes in the cross-sectional plane and the second unit zones may have the same size shape in the cross-sectional plane.

According to an aspect of the present disclosure, the cross-sectional shape of each of the first unit zone and the second unit zone of the intermediate layer zone may satisfy the following conditions:
d1≤T1,
d2≤T2,
50 d1≤W1≤1,000 d1,
50 d2≤W2≤1,000 d2,
wherein T1 is the thickness of the first unit zone, T2 is the thickness of the second unit zone, W1 is the width of the first unit zone, W2 is the width of the second unit zone, d1 is the average particle diameter (D₅₀) of the first granules, and d2 is the average particle diameter (D₅₀) of the second granules.

According to another aspect of the present disclosure, the cross-sectional shape of each of the first unit zone and the second unit zone of the intermediate layer zone may satisfy the following conditions:
d1≤T1≤2 d1,
d2≤T2≤2 d2,
100 d1≤W1≤600 d1,
100 d2≤W2≤600 d2.

According to an aspect of the present disclosure, when W1, W2, T1, and T2 satisfy the above-defined conditions, it is possible to improve the ion diffusion rate and/or electrode capacity of the electrode, but the scope of the present disclosure is not limited thereto.

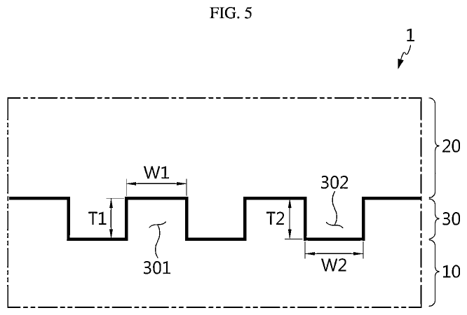

FIG. 5 illustrates the width W1 and thickness T1 of the first unit zone 301, and the width W2 and thickness T2 of the second unit zone 302.

According to an aspect of the present disclosure, when the average particle diameter (D₅₀) of the first granules is d1 and the average particle diameter (D₅₀) of the second granules is d2, d2≥d1. Particularly, d1 may be 15-150 μm, and d2 may be 15-150 μm. When the size of the first granules and the size of the second granules satisfy the above-defined condition, it may lead to advantages in terms of the classification of the first granules and the second granules and the ease of manufacture of electrodes, as well as to provide an improved ion diffusion rate, but the scope of the present disclosure is not limited thereto.

According to another aspect of the present disclosure, d1≥d2, d1 may be 15-150 μm, and d2 may be 15-150 μm.

According to an aspect of the present disclosure, 15 μm≤d1≤60 μm, 15 μm≤d2≤60 μm, and d1≥d2. In addition, 30 μm≤d1≤60 μm, 30 μm≤d2≤60 μm, and d1≥d2. Further, 45 μm≤d1≤55 μm, 45 μm≤d2≤55 μm, and d1≥d2. According to another aspect of the present disclosure, d1>d2.

According to an aspect of the present disclosure, the average particle diameter of the first granules or the second granules may be 2-5 times, and for example, 3-4 times, of the average particle diameter of the other of the first and second granules.

Herein, ‘average particle diameter (D₅₀)’ of the granules means the particle diameter at the point of 50% in the particle number accumulated distribution as a function of particle diameter. The particle diameter may be determined by using the laser diffraction method. Particularly, a powder to be analyzed may be dispersed in a dispersion medium and introduced to a commercially available laser diffraction particle size analyzer (e.g. Microtrac S3500) to measure a difference in diffraction pattern depending on particle size, when the particles pass through laser beams, and then particle size distribution can be calculated. Then, D₅₀ may be determined by calculating the particle diameter at the point of 50% in the particle number accumulated distribution depending on particle diameter in the analyzer system.

According to an aspect of the present disclosure, each of T1 and T2 may be 1-1,000 μm. Preferably, T1 may be equal to or larger than the average particle diameter (D₅₀) of the first granules and may be equal to or smaller than the thickness of the electrode active material layer, and T2 may be equal to or larger than the average particle diameter (D₅₀) of the second granules and may be equal to or smaller than the thickness of the electrode active material layer.

According to an aspect of the present disclosure, each of T1 and T2 may be 1-500 μm, 20-100 μm, 25-75 μm, 25-70 μm, 25-65 μm, 25-60 μm, 30-60 μm, 40-60 μm, 50-60 μm, or 50-55 μm, but is not limited thereto.

According to an aspect of the present disclosure, the second granules for forming the upper layer zone may be contained in the lower layer zone in a certain amount, but it is preferred in terms of the ion diffusion rate of the electrode that the content of the first granules may be 95 wt % or more, 96 wt % or more, 97 wt % or more, 98 wt % or more, 99 wt % or more, 99.5 wt % or more, or 100 wt % (i.e. only the first granules are present) of the total weight of all granules contained in the lower layer zone.

According to another aspect of the present disclosure, the first granules for forming the lower layer zone may be contained in the upper layer zone in a certain amount, but it is preferred in terms of the ion diffusion rate of the electrode that the content of the second granules may be 95 wt % or more, 96 wt % or more, 97 wt % or more, 98 wt % or more, 99 wt % or more, 99.5 wt % or more, or 100 wt % (i.e. only the second granules are present) of the total weight of all granules contained in the upper layer zone.

According to still another aspect of the present disclosure, the content of the first granules may be 95 wt % or more of the total weight of all granules contained in the lower layer zone, and the content of the second granules may be 95 wt % or more of the total weight of all granules contained in the upper layer zone.

According to yet another aspect of the present disclosure, the content of the first granules may be 100 wt % of the total weight of all granules contained in the lower layer zone, and the content of the second granules may be 100 wt % of the total weight of all granules contained in the upper layer zone.

According to an aspect of the present disclosure, as the number, n, of repetition of the first unit zone and the second unit zone is increased, the surface area of the interface formed in the intermediate layer zone is increased. Therefore, it is possible to increase the ion diffusion rate at the interface.

According to an aspect of the present disclosure, when the second granules contained in the upper layer zone have a size larger than the size of the first granules contained in the lower layer zone, the upper layer zone may have a higher porosity due to an increase in interstitial volumes as compared to the lower layer zone. As a result, the upper layer zone may have a higher ion diffusion rate as compared to the lower layer zone. When the upper layer zone has a higher ion diffusion rate as compared to the lower layer zone, it may be possible to inhibit lithium binding on the surface of the electrode and facilitate the diffusion of ions, thereby improving the charging performance of a battery, but the scope of the present disclosure is not limited thereto.

The ion diffusion rate means a degree of diffusion of ions in a specific material. Particularly, unless otherwise stated herein, the ion diffusion rate means a lithium-ion diffusion rate.

There is no particular limitation in the method for determining the ion diffusion rate. For example, the ion diffusion rate may be determined by using the method of Galvanostatic Intermittent Titration Technique (GITT) in a charged/discharged state. According to an aspect of the present disclosure, the ion diffusion rate may be determined by the method of GITT under the condition of 50% SOC (state of charge) and may be expressed in the unit of cm²/s, but is not limited thereto.

According to another aspect of the present disclosure, the intermediate layer zone may have a higher ion diffusion rate as compared to the upper layer zone. This may result from a decrease in the packing density of the granules in the intermediate layer zone as compared to the upper layer zone and an increase in the porosity of the intermediate layer zone as compared to the upper layer zone, but the mechanism of the present disclosure is not limited thereto.

Herein, ‘porosity’ refers to a ratio of the volume occupied by pores compared to the total volume in a given structure. The porosity may be expressed in the unit of vol %, and may be used interchangeably with such terms as pore ratio, porous degree, or the like. For example, the porosity of the electrode may be determined by the Brunauer-Emmett-Teller (BET) method using nitrogen gas or Hg porosimetry according to ASTM D-2873. Further, the net density of an electrode may be calculated from the density (apparent density) of the electrode and the compositional ratio of ingredients contained in the electrode and density of each ingredient, and the porosity of the electrode may be calculated from the difference between the apparent density and the net density. For example, the porosity may be calculated according to the following Formula 1:

$$Porosity ( vol \% ) = \{ 1 - ( Apparent density / Net density ) \} \times 100 \qquad [ Formula 1 ]$$

In Formula 1, the apparent density may be calculated according to the following Formula 2:

$$Apparent density ( g / {cm}^{3} ) = ( Weight ( g ) of porous substrate ) / \{ ( Thickness ( cm ) of porous substrate ) \times ( Area ( {cm}^{2} ) of porous substrate ) \} \qquad [ Formula 2 ]$$

According to an aspect of the present disclosure, the intermediate layer zone may have a porosity of 10-50 vol %, or 20-40 vol %, but is not limited thereto.

According to an aspect of the present disclosure, the intermediate layer zone may have a higher porosity as compared to the upper layer zone and the lower layer zone. For example, the intermediate layer zone may have a porosity corresponding to a value higher by 10-200%, such as 30-100%, as compared to the porosity of each of the upper layer zone and the lower layer zone, but the scope of the present disclosure is not limited thereto.

According to an aspect of the present disclosure, when the second granules contained in the upper layer zone have a lower ion diffusion rate as compared to the first granules contained in the lower layer zone, the upper layer zone may have a lower ion diffusion rate as compared to the lower layer zone. Such a lower ion diffusion rate in the upper layer zone increases the lithium binding in the upper layer zone, and thus lead to improved energy density of the upper layer zone of the electrode. In this manner, it is possible achieve an upper layer zone with improved electrode capacity compared to the lower layer zone.

According to another aspect of the present disclosure, the electrode capacity per volume of the upper layer zone may be higher than the electrode capacity per volume of the lower layer zone.

According to an aspect of the present disclosure, when the first granules contained in the lower layer zone have a lower ion diffusion rate as compared to the second granules contained in the upper layer zone, the lower layer zone may have a lower ion diffusion rate as compared to the upper layer zone. Such a lower ion diffusion rate in the lower layer zone is believed to increase the lithium binding in the lower layer zone, and thus can lead to improved energy density of the lower layer zone. In this manner, it is possible to achieve a lower layer zone with improved electrode capacity compared to the upper layer zone.

According to another aspect of the present disclosure, the electrode capacity per volume of the lower layer zone may be higher than the electrode capacity per volume of the upper layer zone.

The electrode capacity per volume refers to the electrode capacity measured based on the same volume of the electrode, and may be determined by measuring the discharge capacity in a charged/discharged condition, but is not limited thereto. For example, the electrode capacity per volume may be determined as discharge capacity when each of electrode samples prepared with the same volume is charged at 25° C. under a constant current (CC) condition at 0.1 C to 3.0 V (vs Li/Li⁺) and discharged at a current density of 0.1 C to 1.7 V (vs Li/Li⁺).

According to an aspect of the present disclosure, the intermediate layer zone is disposed between two electrode active material layers (having a difference in electrode capacity per volume as mentioned above) to increase the effective area of the interface between the upper layer zone and the lower layer zone. In this manner, improvement of the electrode capacity based on the total volume of the electrode may be achieved.

According to an aspect of the present disclosure, the electrode active material layer may have a total thickness of 50-120 μm, particularly 70-112 μm. Herein, based on the total thickness of the electrode active material layer, the intermediate layer zone may have a thickness of 15-40 μm, particularly 20-40 μm, or 27-37 μm. In addition, for example, each of the upper layer zone and the lower layer zone may have a thickness of 15-40 μm, particularly 20-40 μm, or 27-37 μm.

Herein, the total ‘thickness’ of the electrode active material layer, ‘thickness’ of each layer contained therein, or the thickness of W1, W2, T1, or T2, may refer to a value determined by any known method. For example, the thickness may be a value measured by using a thickness gauge (VL-50S-B, available from Mitutoyo), but is not limited thereto.

Next, the structure and composition of the granules contained in the electrode active material layer will be explained in detail.

Herein, the granules contained in the lower layer zone of the electrode active material layer are referred to as the first granules, and the granules contained in the upper layer zone are referred to as the second granules, wherein the first granules and the second granules have different particle sizes from one another. In the intermediate layer zone, the first unit zone includes the first granules and the second unit zone includes the second granules.

The granules include an electrode active material and a binder, and may further include a conductive material, if necessary. Herein, the electrode active material, binder, and conductive material comprising the first granules are referred to as the first electrode active material, the first binder, and the first conductive material, respectively, and the electrode active material, binder, and conductive material comprising the second granules are referred to as the second electrode active material, the second binder, and the second conductive material, respectively.

The granules have a form of a group of particles through the binding of the electrode active material and/or the conductive material with the binder, and the electrode active material layer includes a plurality of granules.

According to an aspect of the present disclosure, when the granule includes an active material, a binder, and a conductive material, the content (wt %) of the binder based on the total weight (100 wt %) of the conductive material may be higher at the surface portion 102 of the granule as compared to the core portion 101 thereof.

Herein, as shown in FIG. 16, the surface portion refers to the zone near the surface of the granule from the surface of the granule to a predetermined depth toward the core of the granule, and the core portion refers to the part other than the surface portion. According to an aspect of the present disclosure, the surface portion may refer to the zone between the surface of the granule and 70% or more (preferably 85% or more, 90% or more, or 95% or more) of the radius from the center of the particle diameter of the granule.

According to an aspect of the present disclosure, in the zone between the surface of the granule and 90% or more of the radius from the center of the particle diameter of the granule, the content of the binder based on the total weight (100 wt %) of the granules may be 50 wt % or more, 60 wt % or more, 70 wt % or more, 80 wt % or more, or 90 wt % or more.

According to another aspect of the present disclosure, in the zone between the surface of the granule and 95% or more of the radius from the center of the particle diameter of the granule, the content of the binder based on the total weight (100 wt %) of the granules may be 50 wt % or more, 60 wt % or more, 70 wt % or more, 80 wt % or more, or 90 wt % or more.

The granule 100 will now be explained in more detail. The granule 100 may include a core portion 101 containing a plurality of electrode active materials; and a surface portion 102 disposed totally or partially outside of the core portion 101 and containing an electrode binder by which the electrode active material particles are bound to one another. In other words, in the core portion 101 of the granule 100, a plurality of electrode active materials form an aggregate while they are in contact with one another through surface contact, linear contact, dot-like contact, or two or more of such contact modes. In addition, in the surface portion 102 of the granule 100, the electrode binder can fix and bind the electrode active materials of the core portion 101 of the granule 100 to one another, while being disposed partially or totally outside of the aggregate.

According to an aspect of the present disclosure, a small amount of binder may also be contained in the core portion 101 to interconnect and fix the electrode active materials in the core portion 101. However, in the core portion 101 of the granule 100, the electrode active materials form an aggregate while they are in contact with one another through surface contact, linear contact, dot-like contact, or two or more of such contact modes, and in the surface portion 102 of the granule 100, the electrode binder can fix and bind the electrode active materials of the core portion 101 of the granule to one another, while being disposed partially or totally outside of the aggregate.

According to an aspect of the present disclosure, the granule may have an aspect ratio of 0.5-1.5. As the aspect ratio approaches 1, the granules become spherical. Particularly, the granule may have an aspect ratio of 0.8-1.2, and more particularly 0.95-1.05. The aspect ratio refers to the ratio of the longer axis length to the shorter axis length of the granule. Herein, the shorter axis length refers to the average value of lengths of 10 granules in the direction of the axis having the shortest length in the granule, and the longer axis length refers to the average value of lengths of 10 granules in the direction of the axis having the longest length in the granule. When the aspect ratio of the granule satisfies the above-defined range, there is an advantage in that the granule may have sufficient flowability suitable for the process.

When the granule further includes a conductive material, the conductive material may be fixed in the granules through the binding between the conductive material and the electrode active material particles or the binding of the conductive material particles among themselves by the binder.

According to an aspect of the present disclosure, the electrode may be a negative electrode, and the electrode active material may be a negative electrode active material.

According to an aspect of the present disclosure, when the electrode is a negative electrode, the first negative electrode active material and the second negative electrode active material may be the same or different from one another, and particular examples thereof may include, but are not limited to: carbon, such as non-graphitizable carbon or graphite-based carbon; metal composite oxides, such as LiₓFe₂O₃ (0≤x≤1), LiₓWO₂ (0≤x≤1) and SnₓMe₁₋ₓMe′_{y}O_{z} (Me: Mn, Fe, Pb, Ge; Me′: Al, B, P, Si, elements of Group 1, 2 or 3 in the Periodic Table, halogen; 0<x≤1; 1≤y≤3; 1≤z≤8); lithium metal; lithium alloy; silicon-based alloy; tin-based alloy; silicon oxides, such as SiO, SiO/C and SiO₂; metal oxides, such as SnO, SnO₂, PbO, PbO₂, Pb₂O₃, Pb₃O₄, Sb₂O₃, Sb₂O₄, Sb₂O₅, GeO, GeO₂, Bi₂O₃, Bi₂O₄ and Bi₂O₅; conductive polymers, such as polyacetylene; Li—Co—Ni type materials; or a mixture of two or more of them.

According to an aspect of the present disclosure, each of the first negative electrode active material and the second negative electrode active material may include a carbonaceous compound.

According to an aspect of the present disclosure, at least one of the first negative electrode active material and the second negative electrode active material includes a carbonaceous compound, and at least one of the first negative electrode active material and the second negative electrode active material includes a silicon-based compound.

According to another aspect of the present disclosure, the first negative electrode active material may include a carbonaceous compound alone, and the second negative electrode active material may include a mixture of a carbonaceous compound with a silicon-based oxide (SiOₓ (0≤x≤2)).

According to still another aspect of the present disclosure, the first negative electrode active material may include a mixture of a carbonaceous compound with a silicon-based oxide, and the second negative electrode active material may include a carbonaceous compound alone.

According to an aspect of the present disclosure, when at least one of the first negative electrode active material and the second negative electrode active material includes a mixture of a carbonaceous compound with a silicon-based oxide, the mixing ratio of the carbonaceous compound: silicon-based oxide may be 9:1-1:9, 9:1-5:5, 9:1-6:4, 9:1-7:3, or 9:1-8:2, in terms of the weight ratio of the carbonaceous compound to the silicon-based oxide, but the scope of the present disclosure is not limited thereto.

According to an aspect of the present disclosure, the first negative electrode active material may include artificial graphite alone, and the second negative electrode active material may include a mixture of SiO with artificial graphite. Particularly, the first negative electrode active material nay include artificial graphite alone, and the second negative electrode active material may include a mixture of artificial graphite with SiO, for example, a mixture containing artificial graphite and SiO at a weight ratio of 9:1-5:5, or 9:1.

According to an aspect of the present disclosure, the electrode may be a positive electrode, and the electrode active material may be a positive electrode active material.

According to an aspect of the present disclosure, when the electrode is a positive electrode, the first positive electrode active material and the second positive electrode active material may be the same or different from one another, and particular examples thereof may include, but are not limited to: lithium transition metal oxides; lithium metal iron phosphates, lithium nickel-manganese-cobalt oxides; lithium nickel-manganese-cobalt oxides partially substituted with other transition metals; or two or more of them. Particularly, the positive electrode active material may include, but are not limited to: layered compounds, such as lithium cobalt oxide (LiCoO₂) and lithium nickel oxide (LiNiO₂), or those compounds substituted with one or more transition metals; lithium manganese oxides, such as Li₁₊ₓMn₂₋ₓO₄ (wherein x is 0-0.33), LiMnO₃, LiMn₂O₃ and LiMnO₂; lithium coper oxide (Li₂CuO₂); vanadium oxides, such as LiV₃O₈, LiV₃O₄, V₂O₅ or Cu₂V₂O₇; Ni site-type lithium nickel oxides represented by the chemical formula of LiNi₁₋ₓMₓO₂ (wherein M is Co, Mn, Al, Cu, Fe, Mg, B or Ga, and x is 0.01-0.3); lithium manganese composite oxides represented by the chemical formula of LiMn₂₋ₓMₓO₂ (wherein M is Co, Ni, Fe, Cr, Zn or Ta, and x is 0.01-0.1) or Li₂Mn₃MO₈ (wherein M is Fe, Co, Ni, Cu or Zn); lithium metal phosphates LiMPO₄ (wherein M is Fe, CO, Ni or Mn); lithium nickel-manganese-cobalt oxides Li₁₊ₓ(NiₐCO_{b}Mn_{c})₁₋ₓO₂ (x is 0-0.03, a is 0.3-0.95, bis 0.01-0.35, c is 0.01-0.5, a+b+c=1); lithium nickel-manganese-cobalt oxides partially substituted with aluminum (lithium-nickel-manganese-cobalt-aluminum oxide) Lia [Ni_{b}Co_{c}Mn_{d}Alₑ]_{1-f}M₁^{f}O₂ (wherein M¹ is at least one selected from the group consisting of Zr, B, W, Mg, Ce, Hf, Ta, La, Ti, Sr, Ba, F, P and S, 0.8≤a≤1.2, 0.5≤b≤0.99, 0<c<0.5, 0<d<0.5, 0.01≤e≤0.1, and 0≤f≤0.1); lithium nickel-manganese-cobalt oxides partially substituted with other transition metals Li₁₊ₓ(NiₐCo_{b}Mn_{c}M_{d})₁₋ₓO₂ (wherein x is 0-0.33, a is 0.3-0.95, b is 0.01-0.35, c is 0.01-0.5, d is 0.001-0.03, a+b+c+d=1, and M is any one selected from the group consisting of Fe, V, Cr, Ti, W, Ta, Mg and Mo); disulfide compounds; Fe₂(MoO₄)₃; or a mixture of two or more of them.

According to an aspect of the present disclosure, the first binder and the second binder may be the same or different from one another, and the binders are not particularly limited, as long as they desirably have adhesiveness, are stable against electrochemical reactions, can retain the shape of granules through the binding of the electrode materials (such as the electrode active material and the conductive material), allow the granules to be integrated in a layered structure through the binding among themselves upon compression, and maintain a stable shape. Particular examples of each of the first binder and the second binder may include, but are not limited to: styrene butadiene rubber (SBR), butadiene rubber (BR), nitrile butadiene rubber (NBR), styrene butadiene styrene block copolymer (SBS), styrene ethylene butadiene block copolymer (SEB), styrene-(styrene butadiene)-styrene block copolymer, natural rubber (NR), isoprene rubber (IR), ethylene-propylene-diene terpolymer (EPDM), poly(ethylene-co-propylene-co-5-methylene-2-norbornene), polytetrafluoroethylene (PTFE), polyvinylidene fluoride, polyvinyl chloride, polyvinylidene fluoride-co-hexafluoropropylene, polyvinylidene fluoride-co-trichloroethylene, polymethyl methacrylate, polyethylhexyl acrylate, polybutyl acrylate, polyacrylonitrile, polyvinyl pyrrolidone, polyvinyl acetate, polyethylene, polypropylene, polyethylene-co-vinyl acetate, polyethylene oxide, polypropylene oxide, polyarylate, cyanoethyl pullulan, cyanoethyl polyvinyl alcohol, or two or more of them. More particularly, the binder may include, but are not limited to: styrene butadiene rubber (SBR), nitrile butadiene rubber (NBR), polymethyl methacrylate, polyethylhexyl acrylate, polybutyl acrylate, or two or more of them.

According to an aspect of the present disclosure, the first conductive material and the second conductive material may be the same or different, and are not particularly limited, as long as they cause no chemical change in the corresponding battery. Particular examples of each of the first conductive material and the second conductive material may include, but are not limited to: graphite, such as natural graphite or artificial graphite; carbon black-based carbonaceous compound, such as carbon black, acetylene black, ketjen black, channel black, furnace black, lamp black, or thermal black; conductive fibers, such as carbon fibers or metal fibers; fluorocarbon; metal powder, such as aluminum or nickel powder; conductive whisker, such as zinc oxide or potassium titanate; conductive metal oxide, such as titanium dioxide; conductive polymer such as a polyphenylene derivative; or the like. According to a particular aspect of the present disclosure, each of the first conductive material and the second conductive material may be any one selected from the above-listed materials, or a mixture of two or more of them, but the scope of the present disclosure is not limited thereto.

According to an aspect of the present disclosure, the granules may be prepared by mixing an electrode active material and a binder with a solvent to prepare a slurry in a fluidized phase; and then spray drying the slurry. As describe above, the granules may further include a conductive material, if necessary. In addition, the granules may further include other additives for improving the performance.

The electrode active material and the binder, and, optionally, a conductive material and/or an additive, are dispersed or dissolved in a dispersion medium (solvent for the electrode binder) to obtain a slurry including the electrode active material and the binder dispersed or dissolved therein.

The dispersion medium used to obtain the slurry may most suitably be water, but an organic solvent may also be used. Particular examples of the organic solvent include: an alkyl alcohol, such as methyl alcohol, ethyl alcohol, or propyl alcohol; alkyl ketone, such as acetone or methyl ethyl ketone; ether, such as tetrahydrofuran, dioxane, or diglyme; amide, such as diethylformamide, dimethylacetoamide, N-methyl-2-pyrrolidone (also referred to as NMP hereinafter), or dimethyl imidazolidinone; sulfur-based solvent, such as dimethyl sulfoxide or sulfurane; or the like. However, the organic solvent is preferably an alcohol. When an organic solvent having a lower boiling point than water is used in combination, it is possible to increase the drying rate during fluidization granulation. In addition, since the dispersibility or solubility of the electrode binder may be changed, the viscosity or flowability of the slurry may be controlled depending on the amount or type of the dispersion medium, so as to improve production efficiency.

The amount of the dispersion medium used when preparing the slurry may be generally such an amount that the solid content of the slurry may be 1-50 wt %, 5-50 wt % or 10-30 wt %.

The method or order of dispersing or dissolving the electrode active material, the binder, or the like, is not particularly limited. For example, such methods may include a method of adding the electrode active material and the binder to the dispersion medium and mixing them, a method of dissolving or dispersing the binder in the dispersion medium, adding the electrode active material finally and mixing them, or the like. When the slurry includes a conductive material and/or an additive, such ingredients may be introduced during the introduction of the electrode active material. Particular examples of the mixing means may include a mixing system, such as a ball mill, sand mill, bead mill, pigment dispersion system, stone mill, ultrasonic dispersion system, homogenizer, planetary mixer, or the like. For example, the mixing may be carried out at a temperature ranging from room temperature to 80° C. for 10 minutes to several hours.

Next, the slurry may be spray dried. The spray drying method may include spraying and drying the slurry in hot air. Typical examples of systems used for a spray drying process include atomizers. The atomizers may be classified into those for a rotary disc process and those for a pressurization process. The rotary disc process includes introducing the slurry substantially to the center of a disc rotating at a high speed, allowing the slurry to be located outside of the disc by the centrifugal force of the disc, and drying the slurry at that time in a fog-like phase. The disc rotation speed depends on the size of the disc, but generally may be 5,000-35,000 rpm, preferably 15,000-30,000 rpm. Meanwhile, the pressurization process may include pressurizing the slurry and drying the slurry in a fog-like phase from a nozzle.

The temperature of the sprayed slurry is generally room temperature, but may be warmed to a temperature higher than room temperature. The hot air temperature during spray drying may be controlled to 80-250° C., preferably 100-250° C., based on the reactor inlet temperature (upon the introduction) in terms of formation of a granule structure having a high content of binder on the surface. According to an aspect of the present disclosure, the hot air temperature may be controlled preferably to 175-220° C., more preferably 180-220° C., considering the gradient of binder content and the aspect ratio. In the spray drying method, the method for hot air suction is not particularly limited. For example, the hot air suction method may include a method using hot air flowing parallel to the direction of spraying in the horizontal direction, a method of spraying slurry near the top of a drying tower and allowing the sprayed slurry to drop together with hot air, a method of allowing the sprayed drops to be in contact with hot air in a counter-current mode, a method of allowing the sprayed drops to flow parallel to initial hot air first, and then to drop by gravity so that they may be contact with hot air in a counter-current mode, or the like. Meanwhile, according to an aspect of the present disclosure, the outlet temperature (temperature of hot air discharged from the reactor) of the reactor in the spray drying process may be controlled to 90-130° C.

When the outlet temperature or the difference, ΔT, between the inlet temperature and the outlet temperature is low, it may not be possible to carry out drying sufficiently, and thus particles containing a large amount of residual solvent may be formed, spherical particles having a uniform shape may not be able to be formed, and the granules may be agglomerated or may be formed into an amorphous state. Meanwhile, when the inlet temperature is excessively high and ΔT is large, over-drying may occur and granulation may not be able to be accomplished, and particles having an excessively small particle diameter (D₅₀) and a low aspect ratio may be formed. Therefore, in order to realize a high aspect ratio, to inhibit agglomeration of the binder, and to control the particle size to a suitable level, it may be important to control the inlet temperature and the outlet temperature to a suitable range.

In addition, the product, i.e. granule, obtained from the spray drying may be optionally heat treated in order to cure the surface thereof, wherein the heat treatment temperature may be generally 80-300° C.

According to an aspect of the present disclosure, the current collector is not particularly limited, as long as it preferably has relatively high conductivity, while not causing any chemical change in the corresponding battery. Particular examples of the current collector include stainless steel, aluminum, nickel, titanium, baked carbon, copper or stainless steel surface-treated with carbon, nickel, titanium, silver, or the like. In addition, fine surface irregularities may be formed on the surface of the current collector to enhance the binding force with the electrode active material. The current collector may be utilized in various shapes, including a film, sheet, foil, net, porous body, foamed body, non-woven web, or the like. Meanwhile, according to an aspect of the present disclosure, the current collector may have a thickness of 10-50 μm, but is not limited thereto. For example, the current collector may have a thickness of 10-20 μm.

According to an aspect of the present disclosure, the current collector may have a primer layer on at least one surface thereof, and the surface may be totally or partially coated with the primer layer. The primer layer may be introduced to improve the binding force between the current collector and the electrode active material layer and to improve electrical conductivity. The primer layer may include a binder and a conductive material. In describing the binder and the conductive material of the primer layer, reference will be made to the above description of the binder and the conductive material of the electrode active material layer.

According to an aspect of the present disclosure, besides the binder and the conductive material, the primer layer may further include a dispersing agent for dispersing such ingredients.

According to an aspect of the present disclosure, the primer layer including the above-mentioned ingredients may have a thickness of 300 nm to 1.5 μm, particularly 700 nm to 1.3 μm, but is not limited thereto.

The electrode active material layer of the electrode according to an aspect of the present disclosure may have a higher ion diffusion rate as compared to a single electrode active material layer and/or multiple electrode active material layers including an interlayer interface having a horizontal linear or planar shape, or other shapes, such as a triangular or trapezoidal shape. Otherwise, when the electrode active material layer according to an aspect of the present disclosure has a similar ion diffusion rate to such other examples, desirably the electrode active material layer according to the aspect of the present disclosure can provide an improved electrode capacity per volume.

In another aspect of the present disclosure, there is provided a method for manufacturing an electrode.

The method for manufacturing an electrode according to an aspect of the present disclosure includes a process of forming an electrode active material layer on at least one surface of a current collector.

According to another aspect of the present disclosure, the process of forming an electrode active material layer includes the steps of:
(S1) applying a plurality of first granules onto at least one surface of the current collector;
(S2) a first pressurization step of pressurizing the applied first granules towards the at least one surface of the current collector to form a pattern of the first granules by using a pressurizing roll defining the pattern;
(S3) applying a plurality of second granules onto the pattern of the pressurized first granules; and
(S4) a second pressurization step of pressurizing the applied second granules towards the at least one surface of the current collector.

The first granules may include a first electrode active material and a first binder for binding the first electrode active material, and the second granules may include a second electrode active material and a second binder for binding the second electrode active material.

According to an aspect of the present disclosure, the first granules and the second granules may satisfy at least one of the following characteristics:
1) a first characteristic that the particle size of the first granules and that of the second granules are different from each other; and
2) a second characteristic that the composition of the first granules and that of the second granules are different from each other.

The process of forming an electrode active material layer is intended to form an electrode active material layer including the above-described upper layer zone, lower layer zone, and an intermediate layer zone disposed between the lower layer zone and the upper layer zone. Herein, the intermediate layer zone has an interface having a cross-section along a cross-sectional plane oriented orthogonally to the plane of the current collector, the cross-section forming a continuous quadrangular shape defined by alternating the first unit zone including the first granules and the second unit zone including the second granules n times.

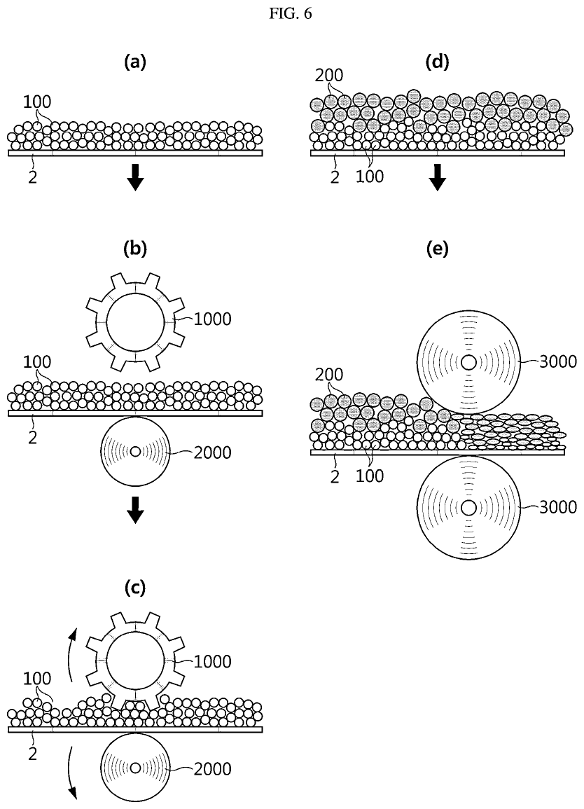

FIG. 6 is a series of illustrations showing the method for manufacturing an electrode according to an aspect of the present disclosure.

Referring to FIG. 6, the method for manufacturing an electrode according to an aspect of the present disclosure includes the steps of: (a) applying a plurality of first granules 100 onto a current collector 2; (b) pressurizing an upper surface of the applied first granules by using a pressurizing roll 1000 having a pattern, e.g., by (c) rolling the pressurizing roll 1000 in opposition to a rolling pressing roll 2000, with the current collector 2 and layer of first granules 100 disposed between them; (d) applying a plurality of second granules 200 onto the upper surface of the pressurized first granules; and (e) pressurizing the surface of the applied second granules, e.g., by rolling two opposed pressing rolls 3000 (which may have smooth/flat outer profiles) with respect to one another while the current collector 2 and the first and second granules 100, 200 pass therebetween.

Particularly, after applying a plurality of first granules 100 onto at least one surface of the current collector 2, the upper surface of the applied first granules is pressurized by using a roll 1000 having a pattern shaped to form a corresponding pattern on the upper surface of the first granules. Herein, the pattern may function as a pre-pattern of the interface of the intermediate layer zone of the resultant electrode active material layer.

According to the present disclosure, a roll having a pattern formed thereon may be used as a pressurizing roll in order to increase the surface area of the interface between the electrode active material layers.

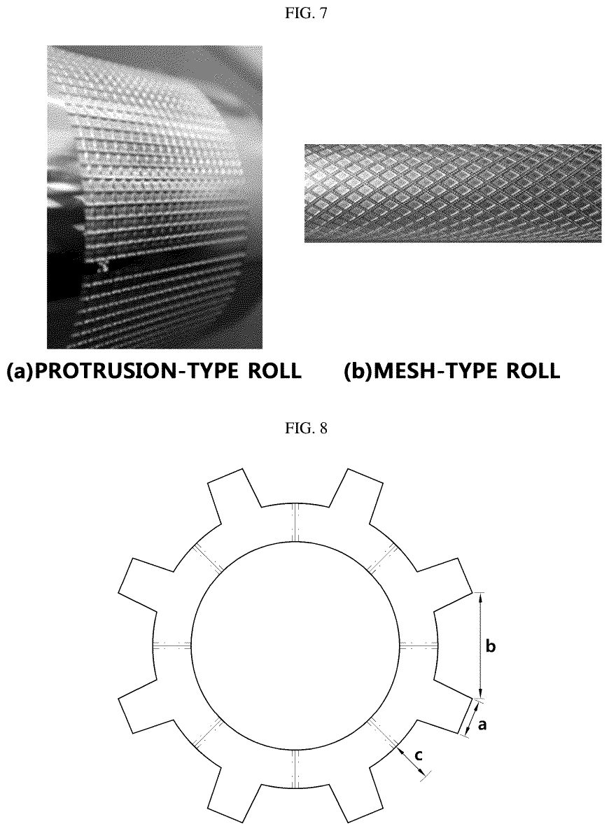

FIG. 7 includes photographic images illustrating the surfaces of different pressurizing rolls having respective patterns, which may be used in step (S2), according to an aspect of the present disclosure.

Referring to FIG. 7, according to an aspect of the present disclosure, the pattern of the pressurizing roll may be a protrusion type pattern (a) protruding outwardly from the central shaft of the roll. Particularly, a roll having a quadrangular shaped protrusion pattern may be used so that each of the first unit zone and the second unit zone may have a quadrangular shaped cross-section.

Referring to FIG. 7, according to another aspect of the present disclosure, the pattern of the pressurizing roll may be a mesh type pattern (b) indented inwardly into the central shaft of the roll.

According to an aspect of the present disclosure, the pattern of the pressurizing roll may include a plurality of quadrangular shaped protrusions.

FIG. 8 shows the shape of the cross-section of a pressurizing roll including protrusions (protruding portions) according to an aspect of the present disclosure. Referring to FIG. 8, a pressurizing roll having protrusions extending parallel to the longitudinal direction of the cylindrical pressurizing roll may be used to form a concave-convex pattern along a lateral (e.g., longitudinal) dimension (or machine direction, MD) of the electrode.

According to another aspect of the present disclosure, a pressurizing roll including protrusions (protruding portions) extending perpendicular to the longitudinal direction of the cylindrical pressurizing roll (and parallel with the opposing end surfaces of the roll in the longitudinal direction of the roll) may be used to form a concave-convex pattern in the electrode. In this case, the concave-convex pattern may be formed in the width dimension (or transverse direction, TD) of the electrode, as shown in FIG. 14.

Referring to FIG. 8, the square shaped protrusions may satisfy the following conditions of W3, W4, and T3:
d2≤T3
50 d2≤W3≤1,000 d2,
50 d1≤W4≤1,000 d1,
where W3 is the width of the protruding portion of the protrusion (corresponding to dimension ‘a’ in FIG. 8), W4 is the shortest linear distance between two protrusions (corresponding to dimension ‘b’ in FIG. 8), T3 is the thickness of the protruding portion of the protrusion (corresponding to dimension ‘c’ in FIG. 8), d1 is the average particle diameter (D₅₀) of the first granules, and d2 is the average particle diameter (D₅₀) of the second granules.

According to an aspect of the present disclosure, the square-shaped pre-pattern of the intermediate layer zone of the electrode active material layer may be formed on the upper surface of the first granules pressurized by the protrusion type pressurizing roll. When the second granules are applied to the surface of the first granules having the pre-pattern formed thereon, the second granules are coated on the surface of the first granules pressurized by the protrusions of the pressurizing roll, thereby forming a second unit zone in the intermediate layer zone of the electrode active material layer.

It is possible to obtain an electrode provided with an electrode active material layer having the above-mentioned lower layer zone, intermediate layer zone, and upper layer zone by applying the second granules to the surface of the first granules having the pre-pattern formed as described above, followed by further pressurization.

Herein, in the further pressurization step of (S4), a pair of pressing rolls having a flat surface as shown in (e) of FIG. 6 may be used.

According to another aspect of the present disclosure, after applying the second granules, the pressurizing roll having a pattern and used in the pressurization of step (S2) may be used again to carry out pressurization, and then a layer of third granules may be applied. In this manner, it is possible to obtain an electrode active material layer including two or more intermediate layer zones in the electrode active material layer.

In addition, the temperature and pressure conditions of each of the processes of granule application and pressurization in each step of (S1) to (S4) are not particularly limited, and any conventional conditions may be used.

In still another aspect of the present disclosure, there is provided an electrode assembly including a positive electrode, a negative electrode, and a separator interposed between the positive electrode and the negative electrode.

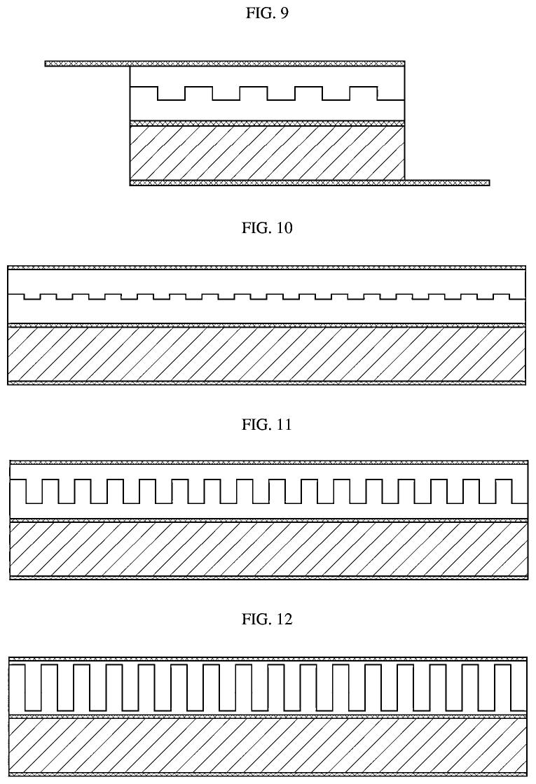

FIG. 9 is a schematic view illustrating the electrode assembly according to an aspect of the present disclosure.

Referring to FIG. 9, the electrode assembly may include a positive electrode and a negative electrode on each of both surfaces of a separator, with the separator interposed between both electrodes, wherein each of the positive electrode and the negative electrode may include an active material layer formed on a current collector, and the current collector may include a non-coated portion (or tab) having no active material layer.

According to an aspect of the present disclosure, at least one of the positive electrode and the negative electrode may be an electrode including no current collector (not shown).

According to the present disclosure, at least one of the positive electrode and the negative electrode may be the above-described electrode including the upper layer zone, lower layer zone, and the intermediate layer zone.

According to an aspect of the present disclosure, referring to FIG. 9, the electrode disposed on the top surface of the separator may be a negative electrode and the electrode disposed on the bottom surface of the separator may be a positive electrode. On the other hand, the electrode disposed on the top surface of the separator may be a positive electrode and the electrode disposed on the bottom surface of the separator may be a negative electrode, but the scope of the present disclosure is not limited thereto.

In FIGS. 10-12, schematic views illustrating electrode assemblies including an electrode according to an aspect of the present disclosure are shown, wherein at least one of the positive electrode and the negative electrode of the electrode assembly includes the upper layer zone, the lower layer zone, and the intermediate layer zone.

In yet another aspect of the present disclosure, there is provided an electrochemical device including a positive electrode, a negative electrode, a separator interposed between the positive electrode and the negative electrode, and an electrolyte, wherein at least one of the positive electrode and the negative electrode is the above-described electrode.

According to an aspect of the present disclosure, the separator and the electrolyte are not particularly limited, as long as they may be used for a conventional electrochemical device without detracting from the objects of the present disclosure. Therefore, detailed description of the separator and the electrolyte will be omitted herein.

According to an aspect of the present disclosure, the outer shape of the electrochemical device may be selected from a coin-like shape, a cylindrical shape, a pouch-like shape, or a prismatic shape with no particular limitation. In addition, the electrochemical device may be used not only for a battery cell used as a power source for a compact device, but alternatively may be a unit cell in a middle- or large-scale battery module that includes a plurality of battery cells, and the applications thereof are not particularly limited.

According to a further aspect of the present disclosure, there is provided an electrochemical device including a positive electrode, a negative electrode, and an electrolyte interposed between the positive electrode and the negative electrode, wherein at least one of the positive electrode and the negative electrode is the above-described electrode. A distinct separator may not be included, and the electrolyte may function as a separator. For example, the electrolyte may be a solid state electrolyte. Thus, the electrochemical device may be a solid state battery.

### MODE FOR DISCLOSURE

Examples, Comparative Examples, and Test Examples will be described more fully hereinafter, so that the present disclosure can be better understood. However, the following examples are for illustrative purposes only in describing the constitution and effects of the present disclosure, and the scope of the present disclosure is not limited thereto.

### Test Example 1. Evaluation of Charging Rate Depending on Height of Interfacial Shape

### [Manufacture of Electrode]

### Preparation of First Granules (Lower Layer Zone)

First, 95.6 wt % of artificial graphite (D₅₀ 15 μm) as an electrode active material, 1.0 wt % of carbon black (Super C65) as an electrode conductive material, 1.1 wt % of carboxymethyl cellulose (daicel 2200, aqueous solution form, solid content 1.5 wt %) as an electrode dispersing agent, and 2.3 wt % of modified styrene butadiene copolymer (grade Name AX-B119) as an electrode binder were mixed with water as a dispersion medium through a homogenizer to prepare a slurry having a viscosity of about 1000 cPs. The slurry had a solid content of 30 wt %. The weight ratio of carboxymethyl cellulose was calculated based on the solid content.

The resultant slurry was introduced into a spray dryer with hot air and dried under a pressure condition of −40 mmH₂O. The spray dryer was controlled to an inlet temperature of 250° C., an outlet temperature of 100° C., and a rotation speed of 18,000 rpm. Macropowder having a size of 150 μm was removed from the resultant granules by using an industrial sieve. The granules were provided with a core portion including a plurality of the electrode active materials and the electrode conductive material, and a surface portion disposed outside of the core portion and including the electrode binder for binding the electrode active materials and the electrode conductive material. The resultant first granules had an average particle diameter (D₅₀) of 50.1 μm and an aspect ratio of 1.04.

### Preparation of Second Granules (Upper Layer Zone)

The second granules were prepared in the same manner as the first granules, except that an artificial graphite mixture (D₅₀ 15 μm): SiO (D₅₀ 6 μm) (weight ratio 9:1) was used as an electrode active material. The resultant second granules had an average particle diameter (D₅₀) of 48.28 μm and an aspect ratio of 1.01.

### Manufacture of Electrode

An electrode was obtained according to the order as shown in FIG. 6, and as follows.

The first granules prepared as described above were applied uniformly to one surface of a copper current collector (thickness 10 μm) by using a thickness-controlling bar in an amount of 200 mg per 25 cm² of the current collector. Pressurization was carried out by using a pressing machine under a pressure of 0.1 ton/cm and a temperature of 60° C. at a rate of 2 m/min. The second granules prepared as described above were applied uniformly to the pressurized surface in an amount of 200 mg per 25 cm² of the current collector. Then a pressing machine provided with a roll having a smooth surface was used to carry out pressurization under a pressure of 0.5 ton/cm and a temperature of 60° C. at a rate of 2 m/min. In this manner, an electrode was obtained.

The pressurizing roll used herein is shown in FIG. 8 in the form of a sectional schematic view. In the pressurizing roll, the protrusions appearing on the cross-section have the same width as one another (represented by dimension ‘a’ in FIG. 8) and are formed in parallel with the longitudinal direction of the cylindrical roll. The protrusions appearing on the cross-section of the pressurizing roll in FIG. 8 are also spaced apart uniformly from one another (represented by dimension ‘b’ in the figure). Three electrodes were obtained with a different interfacial shape of the intermediate layer zone by varying the thickness of the protrusions (represented by dimension ‘c’ in FIG. 8) while retaining the same width (dimension ‘a’) and spacing (dimension ‘b’) of the protrusions. The three electrodes are schematically shown in FIG. 10 (Example 1), FIG. 11 (Example 2), and FIG. 12 (Example 3).

The electrodes as shown in FIGS. 10-12 were formed in such a manner that each electrode had a total length of 509.5 mm and a width of 93.3 mm, and the first unit zone and the second unit zone alternated 30 times. The thickness T1, T2 of the first unit zone and the second unit zone were 3 μm (FIG. 10, Example 1), 27 μm (FIG. 11, Example 2), and 54 μm (FIG. 12, Example 3), as defined by the thickness ‘c’ of the protrusions of the pressurizing roll in FIG. 8.

For comparison with an electrode having a linear/planar interfacial shape between the lower layer zone and the upper layer zone, an electrode pressed by using a conventional flat pressurizing roll with no protrusions was prepared as Comparative Example 1. An electrode was obtained in the same manner as described above, except that the pressurizing roll had such a different shape.

### [Evaluation of Physical Properties]

The electrode (negative electrode) obtained as described above was arranged to face a reference positive electrode with a polyethylene porous membrane interposed therebetween. The resultant structure was pressurized, dipped in an electrolyte, and charged at a rate of 0.5 C and 1 C. Then the time required to reach a state of SOC 100% was measured. The results are shown in the following Table 1.

In addition, to comparatively evaluate the resistance of each electrode, electric current was applied at 2.5 C for 30 seconds, and the resistance value was calculated according to the formula of V=IR. The results are also shown in Table 1.

TABLE 1

| | | | 0.5 C | 1 C | 2.5 C 30 s |
|---|---|---|---|---|---|
| | | Thickness | charging | charging | pulse |
| | n | T1, T2 (μm) | time (s) | time (s) | resistance (Ω) |
| Comp. Ex. 1 | 0 | 0 | 5500 | — | 3.910 |
| Ex. 1 | 30 | 3 | 5650 | 2000 | 3.801 |
| Ex. 2 | 30 | 27 | 5718 | 2000 | 3.800 |
| Ex. 3 | 30 | 54 | 5740 | 2120 | 3.800 |

It can be seen from the results of Table 1 that the charge capacity was improved in the following order: Example 3>Example 2>Example 1. This suggests that when the granules showing a kinetic favorable to the improvement of battery capacity are disposed in the upper layer portion, lithium conduction is facilitated through the interface of the intermediate layer zone, and thus the final charge capacity of the battery may be improved without increasing the resistance.

In particular, it can be seen that when the intermediate layer zone has a flat interface, the battery shows a poor charge capacity and an increased resistance value.

### Test Example 2. Evaluation of Charging Rate Depending on Width (Alternation Number N) of Unit Zones

An electrode was prepared by varying the width W1, W2 of the first unit zone and the second unit zone and varying the alternation number n of the first unit zone and the second unit zone, while retaining the length of the electrode. Then, charging was carried out in the same manner as Example 1 at a rate of 0.5 C, 1 C, and 2 C, and the time required to reach a state of SOC 100% was measured. The results are shown in the following Table 2.

In addition, to comparatively evaluate the resistance of each electrode, electric current was applied at 2.5 C for 30 seconds, and the resistance value was calculated according to the formula of V=IR. The results are also shown in Table 2.

TABLE 2

| | | Thickness T1, | Charging time (s) | | | 2.5 C 30 s pulse |
|---|---|---|---|---|---|---|
| | n | T2 (μm) | 0.5 C | 1 C | 2 C | resistance (Ω) |
| Ex. 4 | 4 | 54 | 5605 | 2040 | 480 | 3.801 |
| Ex. 5 | 8 | 54 | 5730 | 2070 | 490 | 3.800 |
| Ex. 6 | 12 | 54 | 5771 | 2070 | 490 | 3.800 |
| Ex. 7 | 16 | 54 | 5796 | 2090 | 490 | 3.801 |
| Ex. 8 | 20 | 54 | 5797 | 2090 | 500 | 3.800 |
| Ex. 9 | 32 | 54 | 5783 | 2080 | 490 | 3.800 |

It can be seen from the results of Table 2 that when n is 20 and charging is carried out at 0.5 C to 2 C, the highest charging time is accomplished to provide the highest final charge capacity of the electrode. In particular, the resistance value is not significantly changed when varying n, which suggests that the electrode according to the present disclosure can provide improved electrode capacity without increasing the resistance value.

### DESCRIPTION OF DRAWING NUMERALS

1: Electrode active material layer
2: Current collector
10: Lower layer zone
20: Upper layer zone
30: Intermediate layer zone
100: First granules
200: Second granules
301, 301′: First unit zone
302, 302′: Second unit zone
310: Interface
1000: Pressurizing roll having pattern
2000, 3000: Pressing roll

What is claimed is:

1. An electrode comprising:
a current collector defining a plane having a first lateral dimension and a second lateral dimension orthogonal to one another; and
an electrode active material layer disposed on at least one surface of the current collector,
wherein the electrode active material layer comprises:
a lower layer zone adjacent to the current collector and comprising a plurality of first granules;
an upper layer zone disposed above the lower layer zone and comprising a plurality of second granules; and
an intermediate layer zone which is disposed between the lower layer zone and the upper layer zone and in which a first unit zone comprising the first granules and a second unit zone comprising the second granules are disposed in an alternating pattern that alternates along the first lateral dimension of the current collector,
wherein each of the first unit zone and the second unit zone has a quadrangular shaped cross-section along a cross-sectional plane, the cross-sectional plane oriented orthogonally to the plane of the current collector and extending along the first lateral dimension,
wherein the first granules comprise a first electrode active material and a first binder for binding the first electrode active material, and
wherein the second granules comprise a second electrode active material and a second binder for binding the second electrode active material.

2. The electrode according to claim 1, wherein the first lateral dimension corresponds to a longitudinal dimension of the current collector.

3. The electrode according to claim 1, wherein the alternating pattern alternates from once every 20 mm to once every 34 mm along the first lateral dimension of the current collector.

4. The electrode according to claim 1, wherein the first unit zone and the second unit zone are disposed in a second alternating pattern that alternates along the second lateral dimension of the current collector.

5. The electrode according to claim 4, wherein the first unit zone has a first width in the first dimension and the second unit zone has a second width in the first dimension, wherein the first unit zone has a third width in the second dimension and the second unit zone has a fourth width in the second dimension, and wherein at least one of the first and second widths has a different magnitude than at least one of the third and fourth widths.

6. The electrode according to claim 1, wherein the first granules and the second granules satisfy at least one of the following characteristics:
1) a first characteristic that a particle size of the first granules and a particle size of the second granules are different from each other; or
2) a second characteristic that a composition of the first granules and a composition of the second granules are different from each other.

7. The electrode according to claim 1, wherein the quadrangular shaped cross-section of each of the first unit zone and the second unit zone of the intermediate layer zone satisfies the following conditions of T1, T2, W1, and W2:
d1≤T1,
d2≤T2,
50 d1≤W1≤1,000 d1,
50 d2≤W2≤1,000 d2, where:
T1 is a thickness of the first unit zone,
T2 is a thickness of the second unit zone,
W1 is a width of the first unit zone,
W2 is a width of the second unit zone,
d1 is an average particle diameter (D₅₀) of the first granules, and
d2 is an average particle diameter (D₅₀) of the second granules.

8. The electrode according to claim 7, wherein the quadrangular shaped cross-section of each of the first unit zone and the second unit zone of the intermediate layer zone satisfies the following conditions of T1, T2, W1, and W2:
d1≤T1≤2 d1,
d2≤T2≤2 d1,
100 d1≤W1≤600 d1, and
100 d2≤W2≤600 d2.

9. The electrode according to claim 1, wherein an average particle diameter (D₅₀) of the first granules is d1 and an average particle diameter (D₅₀) of the second granules is d2, and wherein d1 and d2 satisfy the following condition:
d2≥d1.

10. The electrode according to claim 1, wherein an average particle diameter (D₅₀) of the first granules is d1 and an average particle diameter (D₅₀) of the second granules is d2, and wherein d1 and d2 satisfy the following conditions:
15 μm≤d1≤150 μm, and
15 μm≤d2≤150 μm.

11. The electrode according to claim 1, wherein the electrode active material comprises a negative electrode active material.

12. The electrode according to claim 1, wherein the electrode active material comprises a positive electrode active material.

13. The electrode according to claim 1, wherein at least one of the first electrode active material or the second electrode active material comprises a carbonaceous compound, and at least one of the first electrode active material or the second electrode active material comprises a silicon-based oxide.

14. The electrode according to claim 1, wherein the second electrode active material comprises SiOₓ, wherein 0≤x≤2.

15. The electrode according to claim 1, wherein a content of the first granules in the lower layer zone is 95 wt % or more of a total weight of all granules contained in the lower layer zone, and a content of the second granules in the upper layer zone is 95 wt % or more of a total weight of all granules contained in the upper layer zone.

16. The electrode according to claim 1, wherein the intermediate layer zone shows has an ion diffusion rate higher than an ion diffusion rate of the upper layer zone.

17. The electrode according to claim 1, wherein the upper layer zone has an electrode capacity per volume higher than an electrode capacity per volume of the lower layer zone.

18. A method for manufacturing an electrode comprising:
applying a plurality of first granules onto at least one surface of a current collector;
a first pressurization step of pressurizing the applied first granules towards the at least one surface of the current collector to form a pattern of the first granules by using a pressurizing roll defining the pattern;
applying a plurality of second granules onto the pattern of the pressurized first granules; and
a second pressurization step of pressurizing the applied second granules towards the at least one surface of the current collector,
wherein the first granules comprise a first electrode active material and a first binder for binding the first electrode active material, and
the second granules comprise a second electrode active material and a second binder for binding the second electrode active material.

19. The method for manufacturing an electrode according to claim 18, wherein the pressurization roll has a protrusion-type pattern or a mesh-type pattern.

20. An electrochemical device comprising:
a positive electrode,
a negative electrode, and
an electrolyte,
wherein at least one of the positive electrode or the negative electrode is the electrode of claim 1.
